(19) United States
(12) Patent Application Publication
(10) Pub. No.: US 2026/0058791 A1
(43) Pub. Date: Feb. 26, 2026

(54) Techniques for Improving Internal Communication of a Fully Homomorphic Encryption (FHE) Accelerator

(71) Applicant: Chain Reaction, Ltd., Tel Aviv (IL)

(72) Inventors: Ilan ROSENFELD, Petah Tikva (IL); Noam KLEINBURD, Hashmonaim (IL); Oren VRUBEL, Tel Aviv (IL)

(73) Assignee: Chain Reaction, Ltd., Tel Aviv (IL)

(21) Appl. No.: 18/809,976

(22) Filed: Aug. 20, 2024

(51) Int. Cl. H04L 9/00; H04L 9/06

(52) U.S. Cl. CPC H04L 9/008; H04L 9/0631

(57) ABSTRACT

A method and device for optimizing dataflow load in an accelerator of a fully homomorphic encryption (FHE) program are provided. The accelerator is configured with a FHE network including a plurality of permute units, and the method includes obtaining a set of program parameters; obtaining a set of optional orderings; determining optimal program parameters to match an ordering of the set of optimal orderings to yield a required dataflow load; and modifying a FHE program to place coefficients in the permute units and perform the permutations based on the optimal program parameters and matching ordering.

### TECHNICAL FIELD

The present disclosure relates generally to fully homomorphic encryption (FHE) programs.

### BACKGROUND

FHE enables computations on encrypted data without needing to decrypt them first. The Cheon-Kim-Kim-Song (CKKS) scheme is one of the encryption methods used in FHE, and it is particularly well-suited for dealing with arithmetic on complex numbers. The core feature of FHE is the ability to perform computations on encrypted data. With CKKS, one can perform addition, subtraction, and multiplication on ciphertexts. These operations correspond to similar operations on the original plaintext numbers. To make the scheme more efficient, a sequence of values can be encrypted into a single ciphertext, this sequence can be rotated. Importantly, CKKS allows these operations to be performed with relatively low noise growth, which is a significant challenge in FHE. As operations are performed on ciphertexts, noise within the encrypted data accumulates. If the noise grows too large, it can make the decrypted result incorrect. CKKS also manages this noise by scaling down ciphertexts after multiplications.

The CKKS scheme includes a technique for controlling this noise called Rescaling, which also reduces the size of the ciphertext. When the size of a ciphertext reaches a threshold, the bootstrapping process can be applied. The bootstrapping process refreshes the ciphertext, increasing its size and enabling more computations to be performed. Bootstrapping is a crucial process that allows FHE schemes to practically perform an unlimited number of homomorphic computations on encrypted data.

The bootstrapping process typically involves three major steps. As illustrated in FIG. 1, the first step, 110, is the coefficients to slots (C2S) step, followed by a polynomial evaluation (Sine) step 120, and the final step is the slots to coefficients (S2C) step 130. In an FHE scheme, an encrypted message is presented as a polynomial. The C2S step 110 homomorphically evaluates the inverse discrete-Fourier-transform (IDFT) and produces a ciphertext that can be evaluated. The Sine step 120 implements the homomorphic modular reduction on the ciphertext. The modular reduction is approximated by a sinusoidal (Sine) function, which scales the message down and produces a remainder polynomial of the modular operation (typically modulo 1). Then, the message is scaled back. The scheme parameters determine the range and degree of the approximation, where the Sine step 120 has to account for the secret-key density ‘h’. The S2C step 130 homomorphically evaluates the DFT on the ciphertext to revert to approximately the original encrypted message.

The bootstrapping process is a crucial part of an application that performs the FHE operation. This process is executed to ensure that noise resulting from operations does not grow too large, which may lead to an incorrect decrypted result. The frequency of executing the bootstrapping process is determined by the application programmer and must be frequent enough to maintain the accuracy of the decrypted result.

The process of bootstrapping is usually complex and requires a significant amount of computational and memory resources. Furthermore, the execution of FHE programs involves extensive intra-chip data movement. This data movement is due to polynomial computations, specifically permutations on a polynomial level, which are performed during the execution of bootstraps or other FHE programs.

The movement of data within the chip requires a very high bandwidth and results in higher power consumption by a processor (chip) running the FHE program. For instance, in a typical configuration, the bandwidth would be 500 Tb/sec for a chip operating at a 1 GHz clock speed, with a total power consumption of 200 watts. The necessary bandwidth and power consumption specifically for permutation dataflow alone are impractical.

In order to effectively implement FHE in real-time commercial applications, it is essential to minimize internal dataflows to prevent them from becoming a bottleneck. Overcoming this bottleneck may lead to increased utilization of computational resources and reduced power consumption.

It would, therefore, be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later.

A system of one or more computers can be configured to perform particular operations or actions by virtue of having software, firmware, hardware, or a combination of them installed on the system that, in operation, causes or causes the system to perform the actions. One or more computer programs can be configured to perform particular operations or actions by virtue of including instructions that, when executed by a data processing apparatus, cause the apparatus to perform the actions.

Some implementations herein relate to a method. For example, the method may include obtaining a set of program parameters. The method may also include obtaining a set of optional orderings; determining optimal program parameters to match an ordering of the set of optimal orderings to yield a required dataflow load; and modifying an FHE program to place coefficients in the permute units and perform the permutations based on the optimal program parameters and matching orders. Other embodiments of this aspect include corresponding computer systems, apparatus, and computer programs recorded on one or more computer storage devices, each configured to perform the actions of the methods.

Some implementations herein relate to a method. For example, non-transitory computer-readable medium may include one or more instructions that, when executed by one or more processors of a device, cause the device to: obtain a set of program parameters; obtain a set of optional orderings determine optimal program parameters to match an ordering of the set of optimal orderings to yield a required dataflow load; and modify a FHE program to place coefficients in the permute units and perform the permutations based on the optimal program parameters and matching ordering. Other embodiments of this aspect include corresponding computer systems, apparatus, and computer programs recorded on one or more computer storage devices, each configured to perform the actions of the methods.

Some implementations herein relate to a device. For example, the device may include one or more processors configured to: obtain a set of program parameters; obtain a set of optional orderings determine optimal program parameters to match an ordering of the set of optimal orderings to yield a required dataflow load; and modify a FHE program to place coefficients in the permute units and perform the permutations based on the optimal program parameters and matching ordering. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 illustrates the steps of a bootstrapping process in an FHE scheme.

FIG. 2 is a diagram of a server utilized to explain the various disclosed embodiments.

FIG. 3 is a diagram of a server utilized to explain the various disclosed embodiments.

FIG. 4 shows the architecture of a processor of the FHE accelerator according to an embodiment.

FIG. 6 is a flowchart of a method for determining the optimal configuration of the FHE network according to an embodiment.

FIG. 7 shows the operation of where the FHE program is a bootstrapping process and the parameters are BTS parameters.

FIG. 8A shows a dataflow load performed as a regular ordering according to an embodiment.

FIG. 8B shows a dataflow load performed as even-odd ordering according to an embodiment.

FIG. 9A shows an arrangement of a regular ordering on an example FHE network according to an embodiment.

FIG. 9B shows an arrangement of one variant of a Bit-Reverse based ordering on an example FHE network according to an embodiment.

FIG. 9C shows an arrangement of an Even-Odd ordering on an example FHE network according to an embodiment.

FIG. 9D shows an arrangement of an additional variant modified of a Bit-Reverse ordering on the FHE network according to an embodiment.

FIG. 10 shows an arrangement of a rotate-by-one ordering on an example FHE network according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The disclosed subject matter addresses technical problems related to optimizing the execution of the fully homomorphic encryption (FHE) program. This optimization involves reducing the amount of data and dataflows within an FHE accelerator, which leads to increased utilization of computational resources and lower power consumption. Implementing these improvements in an FHE accelerator or any dedicated hardware would enable real-time commercial applications of FHE.

Some of the disclosed embodiments allow for reducing dataflows within an FHE accelerator by selecting an optimized order of polynomial coefficients to be placed in the FHE accelerator. The optimized order ensures that permutations at the polynomial level would be performed at the least number of transfers of polynomial coefficients from one location to another in the accelerator, thereby reducing the number of transfers of dataflows. As noted below, fewer intra-chip data transfers lead to increased utilization of computational resources and a reduction in power consumption.

Typically, operations involved in Fully Homomorphic Encryption (FHE) include polynomial operations. These operations can be very costly due to the high degree of the polynomial (e.g., degree N=2¹⁶ or 2¹⁷) and the large coefficient size (e.g., log_{Q}=2,000).

FHE operations require polynomial operations. Due to the fact that a polynomial degree N is very high (e.g., degree N=2¹⁶ or 2¹⁷) and the coefficient size is very big (e.g., log=2,000), this type of polynomial arithmetic is very costly in terms of the memory and compute resources.

A polynomial has N coefficients, each represented in RNS by a changing number (L) of residues. Thus, a typical description can be a matrix of L×N elements. There are a number of polynomial operation types: Inter-Polynomial, Inter-Residue, and Inter-coefficient—including NTT, and permutation.

Inter-Polynomial operations operate elementwise between elements of two polynomials of the same dimension. They require the highest bandwidth, and therefore, all values at the coordinate (residue, coefficient) of all polynomials will be placed in the closest proximity possible. Inter-Residue operations include input and output values at a fixed coefficient and different residues. If not all residues are in close proximity, then data must be broadcast from one area to the rest of the chip. Inter-coefficient operations either perform arithmetic or move data at a fixed residue and different coefficients. NTT is an operation with an all-to-all scatter data movement pattern. No escape from chip-wide communications applies here, resulting in major bandwidth and energy requirements. Permutation is an operation that involves a set of specific data movement patterns.

Existing designs of FHE accelerator implementations, an example of which is discussed below, incorporate an all-to-all scatter to implement permutation, resulting in another major bandwidth and energy requirement (the same order of magnitude as an NTT operation).

The disclosed embodiments enhance the permutations' execution on the FHE accelerator without compromising other performance metrics, such as the costs of Inter-Residue data. Such improvements can be achieved during a bootstrapping process and other parts of an FHE program.

A bootstrapping process as part of an FHE program requires polynomial operations. For example, the C2S step performs an inverse DFT process on the ciphertext ct. DFT processes can be expressed in the form of multiplication between a plaintext matrix D and an input vector v. The plaintext matrix D can be decomposed into pblock-diagonal sparse matrices M₀, M₁, . . .

$${M}_{ρ - 1} ( 1 \leq ρ \leq {log}_{2} \frac{N}{2} ) ,$$

where N is the length of a plaintext polynomial.

Then, homomorphic multiplication between each matrix M and an input vector v is performed by encoding the matrix's diagonals as plaintexts and using the ciphertext as the vector. The multiplication uses the Baby-step Giant-step (BSGS) algorithm, which rotates the input ciphertext and multiplies each rotation by appropriate diagonals. The result is the sum of all products.

Generally, the key-switching process involves creating a special key, a key-switching key (KSK), that relates to the original encryption key. This special key is used to transform the ciphertext back to being under the original encryption key after operations like ciphertext multiplication change the encryption key under which the result is being obtained. The key-switching process includes mathematical operations that ensure the underlying plaintext remains unchanged and that the transformation does not introduce significant additional noise. The exact mathematical operations of the key-switching process depend on the FHE scheme being used. The S2C step performs similar operations using a DFT operation.

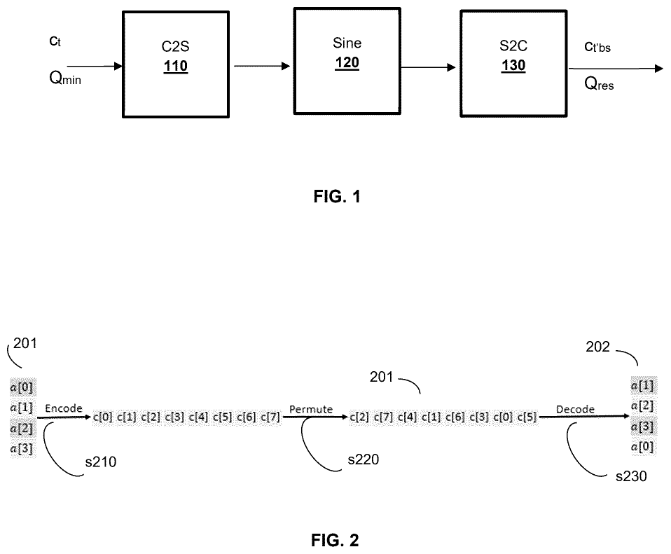

The rotation operation is carried out by permuting (changing the order of the polynomial coefficients). This is further demonstrated with reference to FIG. 2. A vector ‘a’ 201 is a vector of 4 complex numbers encoded at step (s210) by a polynomial of order 8. The rotation step (s220) is performed by permuting the order of the polynomial coefficients. That is, the rotation can be represented as: rot(c, r). For example, when the rotation is r=2, a coefficient c[2] is moved to c[0], a coefficient c[7] is moved to c[1], and so on. It should be noted that permutations include moving the coefficients to form a new shuffled order of the coefficients. Mathematically, in the case of ciphertext, the use of a key switching key, after permutation, is needed to keep the ciphertext under the original key.

The decoding step (s230) transforms the polynomial back to a complex vector 202, which is a rotated version of the original vector (201).

Mathematically, the example demonstrated in FIG. 2 can be expressed as follows: Let mₐ(x) be the polynomial of order N, encoding a, a vector of

$$n \leq \frac{N}{2}$$

complex numbers. Let m_{R}_{ᵣ}(x) be the polynomial of order N, encoding

$${R}_{r} = R o t ( a , r ) , so {R}_{r} [ k ] = a [ ( k + r ) mod \frac{N}{2} ]$$

Let Mₐ, M_{R}_{ᵣ} be the evaluation-mode representation of mₐ(x) and m_{R}_{ᵣ}(x):

$${M}_{{R}_{r}} [ k ] = {M}_{a} [ \frac{( {5}^{r} ( 2 \cdot k + 1 ) - 1 ) mod 2 N}{2} ] \qquad Equation 1$$

where rotation of the complex vector a is performed by permutations of its encoding polynomial according to Equation 1.

The disclosed embodiments can be applicable in FHE schemes including, but not limited to, CKKS, BGV/BFV, and the like. The disclosure can also be applied to any part of an FHE program, including but not limited to bootstrapping, AI models processed by an FHE program, and so on.

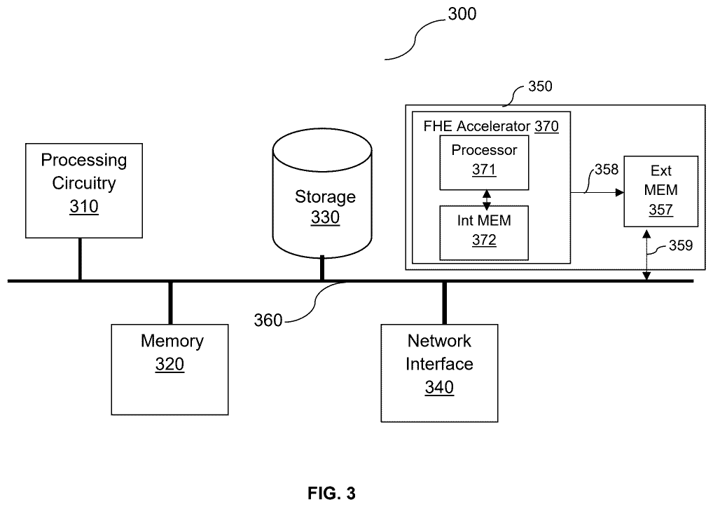

FIG. 3 is an example diagram of a server 300 utilized to explain the various disclosed embodiments. The server 300 includes a processing circuitry 310 coupled to a memory 320, a storage 330, a network interface 340, and an FHE card 350. In an embodiment, the components of the server 300 may be communicatively connected via a bus 360.

The processing circuitry 310 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

Memory 320 may be volatile (e.g., random access memory, etc.), non-volatile (e.g., read-only memory, flash memory, etc.), or a combination thereof. The storage 330 may include a non-volatile memory device, magnetic disk drive, optical disk drive, tape drive, and the like. Examples of memory 320 may include EEPROM, ROM, PROM, RAM, DRAM, SRAM, flash, firmware, programmable logic, and so on. Storage 330 may comprise an internal storage device, an attached storage device and/or a network-accessible storage device, and the like. Network interface 340 allows the server 300 to communicate with external systems. Various communication protocols can be utilized by the network interface 340.

The memory 320 and/or storage 330 may store software required to execute an FHE program or application, that is, a software program that requires the execution of an FHE scheme to perform one or more homomorphic operations. The bus 360 may include, for example, a PCle bus.

The FHE program, according to the disclosed embodiment, is performed by the FHE accelerator 370. It should be noted that software shall be construed broadly to mean any type of instructions, whether referred to as software, firmware, middleware, microcode, hardware description language, or otherwise. Instructions may include code (e.g., in source code format, binary code format, executable code format, or any other suitable format of code).

An FHE card 350 is configured to rapidly perform complex encryption, decryption, and homomorphic operations. The FHE card 350 can be installed on server 300 or operated as a standalone device. The FHE card includes a FHE accelerator 370.

The FHE accelerator 370 includes a processor 371 and an internal memory 372, or several processors with internal memory designed for accelerating FHE scheme computational tasks. The processor 371 may include multiple cores that can handle multiple computation threads simultaneously. Internal memory 372 is a dedicated memory used by processor 371 to store the data for executing the FHE program. Such data may include auxiliary data, encryption keys, indeterminate data, and the like. The internal memory 372 is designed for high bandwidth, which means it can read and write data at high speeds, enabling the processor 371 to quickly access the data stored therein. The internal memory 372 is realized as on-die memory.

In one embodiment, the FHE accelerator 370 can be realized as an ASIC. In other embodiments, the FHE accelerator 370 can be realized as an FPGA, an ASSP, a SoC, and the like, or any other hardware logic components that can perform calculations or other manipulations of information.

The FHE card 350 also includes an external memory 357 and a memory bus 358. A memory bus 358 is an interface through which the processor 371 communicates with the external memory 357. Typically, the external memory 357 is an SDRAM, high bandwidth SDRAM (e.g., GDDR5, GDDR6), or high bandwidth memory (HBM).

The FHE card 350 also includes an interface 359 to interface with the bus 360. As noted, the bus 360, and hence interface 359, is a PCle.

The size of internal memory 372 is significantly smaller than the external memory 357. Internal memory 372 is considered “on-die” memory, and the data stored therein allows for the efficient execution of an FHE scheme, specifically a bootstrapping process for such a program. For example, the difference between the memory size of the external memory and the internal memory may be an order of magnitude. In current technologies, the internal memory size of 372 is limited to 1 GB. Increasing the size of the internal memory 372 would reduce the number of compute resources.

As noted above, the process of bootstrapping is usually complex and requires a significant amount of computational and memory resources. Specifically, a typical FHE bootstrapping process (or simply bootstrapping) would require 10 GB of memory. This is in addition to the memory required to execute other parts of the FHE program. Currently, in existing solutions, data and auxiliary data used for bootstrapping are saved and repetitively loaded from memory 320 or external memory 357 to internal memory 372 during the execution of bootstrapping. In a typical program, bootstrapping occurs hundreds to thousands of times.

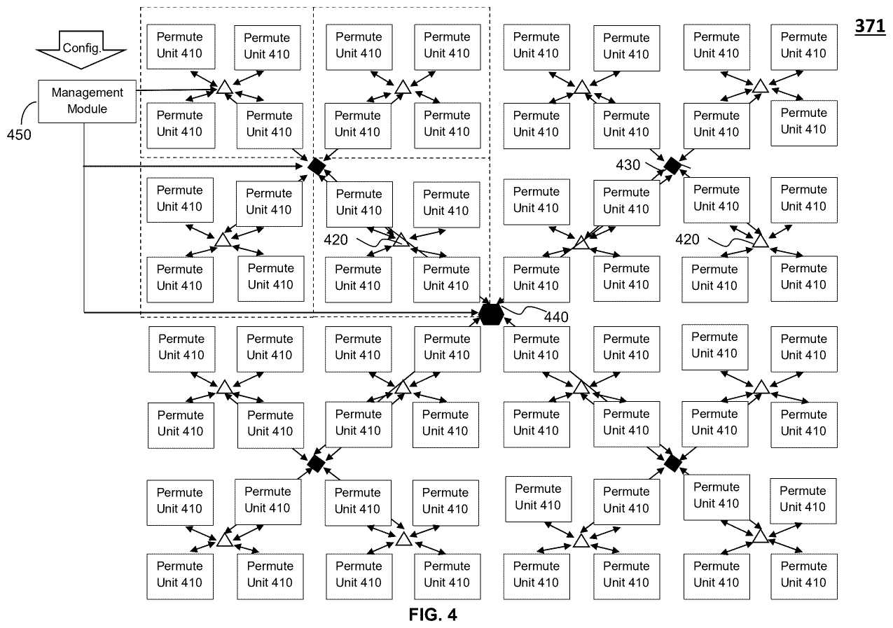

According to the disclosed embodiments, processor 371 is designed to allow permutations and other polynomial operations while reducing the amount of internal data transfers. The architecture of processor 371 is shown in FIG. 4.

It should be understood that the embodiments described herein are not limited to the specific architecture illustrated in FIG. 3, and other architectures may be equally used without departing from the scope of the disclosed embodiments.

FIG. 4 shows an example architecture of processor 371 of the FHE accelerator 370 according to an embodiment. Processor 371 is designed to allow permutations and other polynomial operations while reducing the amount of internal data transfers. The polynomial operations supported by processor 371 include intra-polynomial operations, inter-polynomial operations, NTT, RNS, rotations, and the like. All such polynomial operations are performed on the polynomial coefficients.

In a typical FHE scheme, there are 64K polynomial coefficients on which polynomial operations are performed. Specifically, a bootstrap process requires multiplication and rotations (permutations) during the C2S and S2C steps. The disclosed embodiments further allow for configuring processor 371 in such a way as to allow minimal data transfers.

Processor 371 includes a plurality of permute units 410, connected using switches in a predefined hierarchy. In an example embodiment, the hierarchy is connecting a group of 4 units 410 with a single switch 420, groups of 4 permute units are connected to each other using a switch 430, and the groups of 16 units are connected to each other using a switch 440. Every permute unit 410 may be referred to as a “node.” The example architecture shown in FIG. 4 is referred to as the FHE network. For example, the architecture includes 64 permute units 410, where each unit 410 is configured to operate on 1024 (1K) coefficients. It should be noted that the disclosed embodiments are not limited to the specific architecture shown in FIG. 4. Processor 371 may be designed with a different number of permute units 410, a different number of units in each switch level, a different arrangement of the switches, or a different topology.

In an embodiment illustrated in FIG. 5, a permute unit 410 includes a memory 510 and a permutation circuit 520. Memory 510 can be realized as a set of registers, cache memory, stacks, or other types of data structures. The permutation circuit 520 can be realized as a multiplexer (MUX), a de-multiplexer, an array of switches, and the like. For example, a multiplexer can select one of several input signals and forward the selected input to a single output line.

Returning to the FIG. 4, processor 371 also includes a management module 450 configured to control switches 420, 430, and 440 based on the required permutations and ordering. Management module 450 may also adaptively configure the permute units 410 with the determined placement of coefficients based on the selected order. In an embodiment, management module 450 receives a configuration from processor 371 according to the required dataflow in the network, i.e., the FHE network demonstrated in FIG. 4.

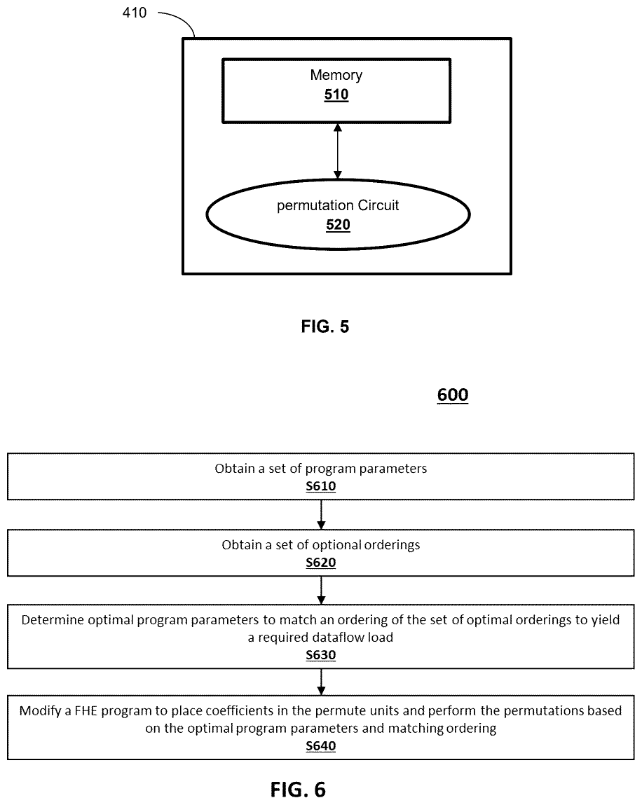

According to the disclosed embodiments, the optimal configuration includes ordering the coefficients in the permute units 410, including internal ordering inside the units, and adaptively configuring the network to permute coefficients across the various permute units 410 so that the amount of internal data transfer would be minimal. In an embodiment, the optimal configuration is determined prior to running an FHE program and can be performed at the stage of compiling or initializing such a program. The method for determining the optimal configuration is discussed in FIG. 6.

The polynomial coefficients may be spatially placed in any arbitrary order in permute units 410 gathered as groups. For example, coefficients 0-1023 are placed in unit 410-1, coefficients 1024-2047 are placed in 410-8, and so on. Also, there may be a specific ordering for the coefficients placed in each unit 410. Operations between coefficients may be required to be implemented on the group level, between close groups, between medium-distance groups, or between highly distant groups. The optimal configuration and the operation of management module 450 allows performing polynomial level permutations by the following sequence:
a) Executing local permutations at a permute units level;
b) Sending groups of coefficients (or a portion thereof) to other permute unit(s); and
c) Executing other local permutations on the inside of each of the permute units.

FIG. 6 is an example flowchart 600 of a method for determining the optimal configuration of the FHE network according to an embodiment. The method may be performed by a server or a computer prior to run time. For example, processing circuitry 310 in server 300 can execute the method disclosed herein.

The optimal configuration includes the selection of program parameters and coefficient orderings that would yield a minimum dataflow load. The dataflow load can be measured as an average energy consumption, a bisection bandwidth, or both.

The average energy consumption is proportional to the average distance traveled per bit. As an example, for a 2-dimensional square layout of coefficients placed in k²=64 permute units, where each unit is of

$$\frac{N}{{k}^{2}} = 1024$$

coefficients. The permute units are uniformly distributed at a distance of d between each adjacent pair. In such a configuration, each permute unit is located at a coordinate (x,y)=(i·d,j·d) 0≤i≤7,0≤j≤7. The Manhattan distance between two permute units is |x₁-x₂|+|y₁-y₂|.

The average distances that bits have traveled between permute units are determined. Any permutation within a permute unit is considered short and can be omitted for gross estimation of travel distance. In an example embodiment, for a given ordering, the average distance is a function of the number of transfers between permute units and the distance between each pair of such units. The power average is a function of the number of bits transferred, energy cost per bit and distance, the physical distance between permute units, and the time that a program runs. The Bisection bandwidth is a function of the number of permutations per second and the number of coefficients. For example, there may be one permutation per nanosecond.

It should be noted that other metrics for measuring the dataflow load are also applicable. Such metrics may be related. There may be more metrics for dataflow load, relating to average or peak (or any other statistical measure) bandwidth of any cross-section of the entire FHE network. The load may be measured as a function of the desired performance of the FHE accelerator. The method will be discussed with a specific reference to an example where the optimal configuration is determined for a bootstrapping process of an FHE program. However, the disclosed embodiments are applicable to other types of FHE programs. An example of an FHE network of an FHE accelerator is presented in FIG. 4.

At S610, a set of program parameters is obtained. The program parameters affect the number of rotations and hence the permutations. The program parameters are derived from the FHE scheme selected for a FHE program. For example, the FHE scheme parameters may include the length of a plaintext polynomial (Degree) N, polynomial modulus Q, Special modulus P, and the like. Examples of bootstrapping parameters may include Qstart, the starting modulus, and Qresd, the residual polynomial modulus, as well as Matrix decomposition options, key-switching keys, and the like.

In an embodiment, the FHE program is a bootstrapping process The bootstrapping process involves three main steps (C2S, Sine, and S2C) and can be performed at any time when a current multiplicative level 1 of the ciphertext becomes too low to proceed without decryption. The purpose of the bootstrapping process is to increase the multiplicative level of the ciphertext to a higher value L>l.

The C2S step performs an inverse DFT process on the ciphertext ct. The iDFT process can be expressed in the form of multiplication between a plaintext matrix D and an input vector v. The plaintext matrix D can be decomposed into p block-diagonal sparse matrices M₀, M₁, . . . , Mₚ₋₁ (1≤p≤log₂ N). Each decomposed block-diagonal sparse matrix (or a “diagonal matrix”) M includes a number of non-zero diagonals, which may be different from one diagonal matrix to another. The variable N is the length of a plaintext polynomial.

Then, homomorphic multiplication between each pair of matrix M and an encryption of vector v is performed by first encoding the diagonals of the matrix as plaintexts and then multiplying by rotated versions of the ciphertext. The multiplication uses the Baby-step Giant-step (BSGS) algorithm, which rotates the input ciphertext and multiplies each rotation by appropriate diagonals. The result is the sum of all products when some products need to be rotated more.

Generally, the key-switching process involves creating a special key that relates to the original encryption key. This special key is used to transform the ciphertext back to being under the original encryption key after operations like ciphertext multiplication that change the encryption key under which the result is being obtained. The key-switching process includes mathematical operations that ensure the underlying plaintext remains unchanged and that the transformation does not introduce significant additional noise. The exact mathematical operations of the key-switching process depend on the FHE scheme being used. The S2C step performs similar operations using a DFT operation.

At S620, a set of optional orderings for the ciphertext polynomial coefficients across the FHE network are obtained. An ordering for the ciphertext polynomial coefficients determines the initial placement of the coefficients in the FHE network or, specifically, permute units 410 in the FHE network discussed above. Typically, there are 64K polynomial coefficients on which polynomial operations are performed, and such polynomial coefficients will be placed or arranged in permute unit 410, where each unit 410 will include 1K coefficients when there are 64 permute units. The arrangement is determined by an ordering of the set of optional orderings.

For a polynomial of N coefficients, and N possible locations in the FHE accelerator, an ordering is a mapping of each coefficient to a distinct physical location. The N physical locations are divided into areas, denoted “Permute Units”. An ordering divides the N coefficients between the permute units, and determines the specific location of each coefficient within each permute unit.

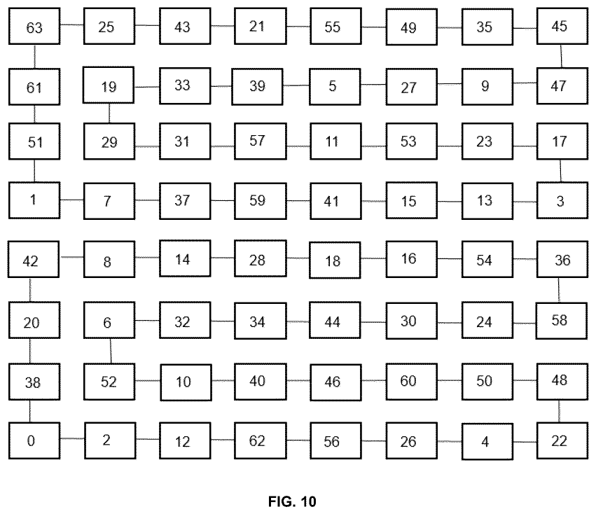

In an embodiment, the optional orderings include Regular, Bit-Reverse, and Even-Odd orderings. These orderings produce different dataflow loads for different rotations (1, 4, 8, 16, etc.). A rotation defines the movement from one permute unit to another, as discussed above. An optional ordering also includes a permutation-specific order, which is mostly effective for a specific permutation and is illustrated in FIG. 10, for an example of rotation by one. The optional orderings are illustrated below. Any rotation is a cyclic shifting of the complex vector slots by the given step (1, 4, 8, 16, etc.).

For example, Bit-Reverse permutation is such that an element in an index i is placed in a position j such that the binary representation of i and j are reversed. As an example, for a given a vector of N=2¹⁶ coefficients a=(a₀, a₁, a₂, a₆₅₅₃₅) its Bit-Reverse permutation is:

$$B i t R e v ( a ) = ( {a}_{B i t R e ν ( 0 )} , {a}_{B i t R e ν ( 1 )} , {a}_{B i t R e ν ( 2 )} , … {a}_{B i t R e ν ( 65535 )} ) = ( {a}_{0} , {a}_{32 \; 768} , {a}_{16 \; 384} , {a}_{49152} , … {a}_{65535} )$$

The Bit-Reverse ordering is any ordering in which all coefficients within any permute unit are a group of consecutive coefficients of the polynomial after Bit-Reverse. That is, for N=2¹⁶,p=4096 (number of permute units), therefore there are 16 coefficients in each permute units, a Bit-Reverse ordering will have the following groups of coefficients in the same permute unit:

$$\begin{matrix}\{ {a}_{B i tRev ( 0 )} , {a}_{B i tRev ( 1 )} , … {a}_{B i tRev ( 15 )} \} in a permute unit \\ \{ {a}_{B i tRev ( 16 )} , {a}_{B i tRev ( 17 )} , … {a}_{B i tRev ( 31 )} \} in a permute unit \\ … \\ \{ {a}_{B i tRev ( 65520 )} , {a}_{B i tRev ( 65521 )} , … {a}_{B i tRev ( 65535 )} \} in a permute unit\end{matrix}$$

The Bit-Reverse may define a number of variants. A variant is how the groups of coefficients are organized in the FHE Net. In an embodiment, the obtained set of optional orderings is selected based on the FHE program. For example, for a bootstrap program, the optional orderings may include Bit-Reverse, Even-Odd, and permutation-specific orderings. The optional orderings may be pre-defined per the FHE program.

It should be noted that S610 and S620 can be performed at parallel or S610 can be performed before S620.

At S630, the FHE program's parameters are optimized to match one of the optional orderings to yield the minimum dataflow load. That is the minimum total dataflow within the FHE network architecture 400 of processor 371. The minimum dataflow load translates to reduced bandwidth and power consumption of the processor 371. In an embodiment, S630 includes determining the required number of rotations for a given set of program's parameters, computing the dataflow load of required permutations for the required number of rotations and a given optimal ordering, and determining the dataflow load based on the required permutations and a given ordering. Then, the set of parameters and the ordering that would result in the minimum dataflow load are selected. To achieve minimum dataflow load within the FHE network, it is desired that most permutations will be performed within the permute units 410 or within close groups of permute units 410 connected by a single switch. That is, each permute unit 410 would perform most of the permutations.

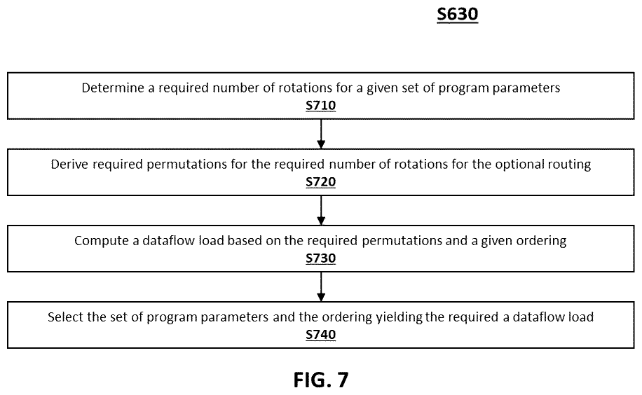

FIG. 7 shows the operation of S630 where the FHE program is a bootstrapping process and the parameters are BTS parameters.

At S710, the required number of rotations for a given set of BTS parameters is computed or determined. The required rotation steps and the required amount of each rotation is a function of several parameters, including the number and size of the block-diagonal sparse matrices decomposition M₀,M₁, . . . , M_{ρ-1} (1≤ρ≤log₂ N), a number of baby steps (n₁) and giant steps (n₂) in the BSGS algorithm, and other possible parameters, such as parameters that determine the operation of the BSGS process.

For example, Table 1 shows BTS parameters that may be selected to run a C2S step of a bootstrapping process. In Table 1, the first row designates a number of p=3 of sub-matrixes

$$( {M}_{32}^{( 0 )} {M}_{63}^{( 1 )} {M}_{63}^{( 2 )} ) ,$$

the values for (n₁,n₂) set as (8,4), (8,8), (8,8). In such a configuration, the required rotations when running a BSGS process on

$${M}_{32}^{( 0 )}$$

are 8192 (3 times, or steps) and 1024 (7 times, or steps); the required rotations when running a BSGS process on

$${M}_{63}^{( 1 )}$$

are −256 (7 times, or steps) and −32 (7 times, or steps); and the required rotations when running a BSGS process on

$${M}_{63}^{( 2 )}$$

are 8 (7 times or steps) and 1 (7 times or steps).

It should be noted that, for example, the highest dataflow load may be for a rotation of 1. On the 2^{nd} row of Table 1, for example, the parameter choice is such that the rotation by 1 for

$${M}_{63}^{( 2 )} \qquad ( 2 )$$

is performed 15 times. Therefore, by minimizing the number of rotations by 1, the dataflow load, and hence bandwidth usage within the processor 371, can be reduced. This can be achieved by the optimal selection of BTS parameters matching an optimal ordering.

TABLE 1

| C2S Matrix Decomposition | (n₁, n₂) | Required Rotations |
|---|---|---|
| $ρ = 3 , {M}_{32}^{( 0 )} {M}_{63}^{( 1 )} {M}_{63}^{( 2 )}$ | (8, 4), (8, 8), (8, 8) | 1024, 8192, −32, −256, 1, 8 |
| $ρ = 3 , {M}_{32}^{( 0 )} {M}_{63}^{( 1 )} {M}_{63}^{( 2 )}$ | (8, 4), (16, 4), (16, 4) | 1024, 8192, −32, −512, 1, 16 |
| $ρ = 3 , {M}_{16}^{( 0 )} {M}_{63}^{( 1 )} {M}_{127}^{( 2 )}$ | (8, 4), (8, 8), (16, 8) | 2048, 8192, −64, −512, 1, 16 |
| $ρ = 4 , {M}_{16}^{( 0 )} {M}_{31}^{( 1 )} {M}_{31}^{( 2 )} {M}_{15}^{( 3 )}$ | (4, 4), (8, 4), (8, 4), (4, 4) | −2048, −8192, 128, 1024, −8, −64, 1, 4 |

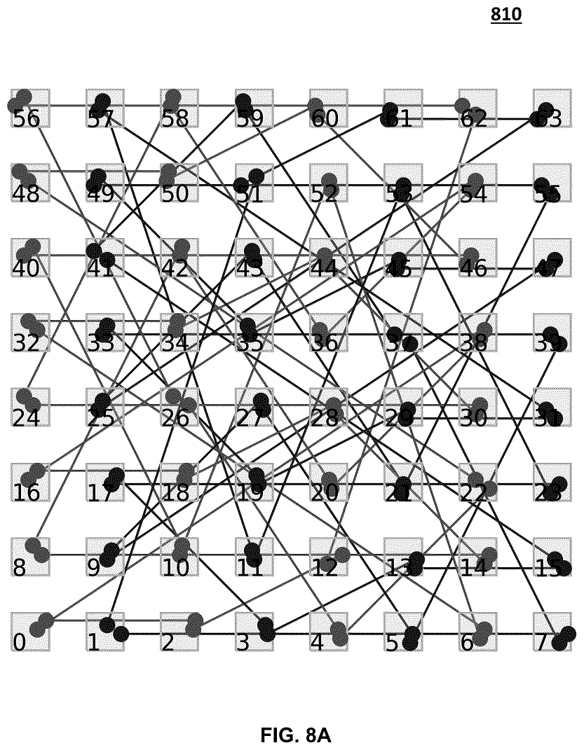

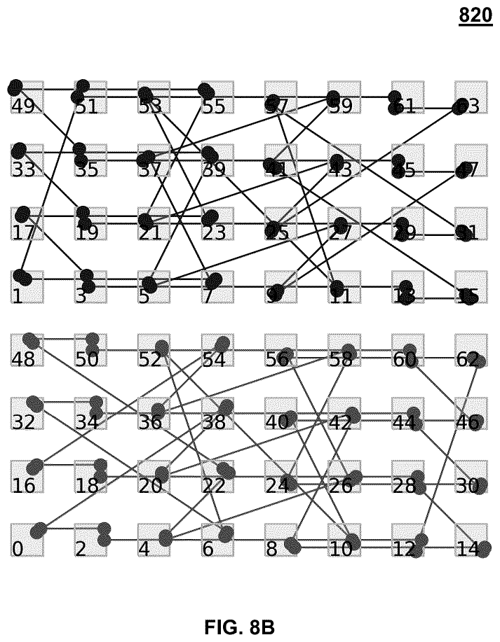

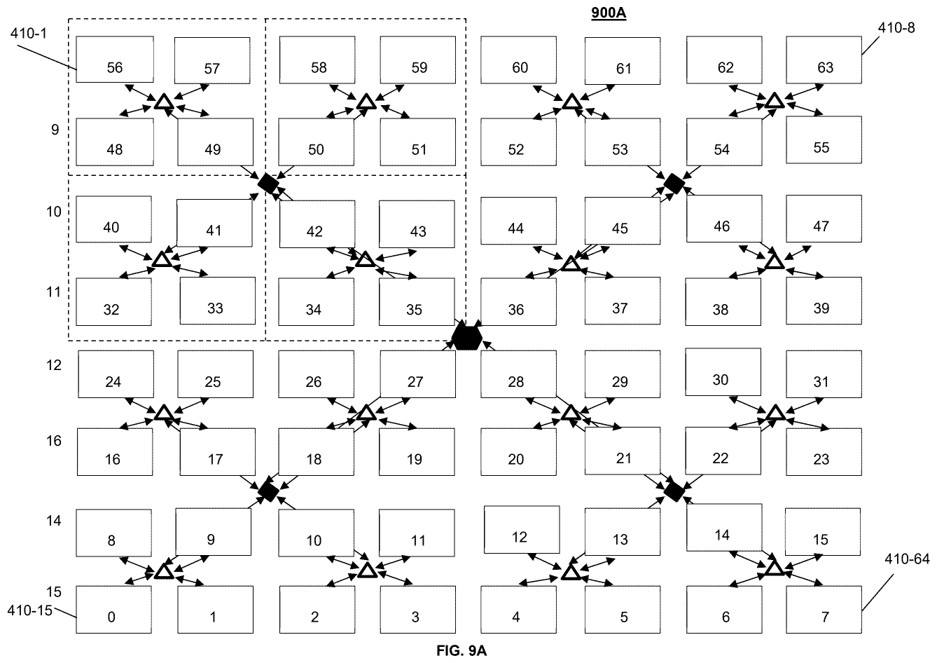

The orderings can also affect the dataflow load when the required rotations are known. For example, as shown in FIGS. 8A and 8B, for a polynomial with 64 coefficients (N=64), where the numbers 0 to 63 represent the index value of the coefficients, a required data movement for “rotate by one” may be performed as a regular ordering 810 (FIG. 8A) and an even-odd ordering 820 (FIG. 8B). As dataflows are movements of coefficients, such dataflows are illustrated as arrows. As schematically demonstrated in FIGS. 8A and 8B, the selected ordering significantly affects the dataflow load.

It should be noted that a dataflow load should be counted or measured as the distance from one permute unit to another. For example, referring to FIG. 8A, dataflows for a rotation between coefficients at locations 56 and 62 may be counted as ‘6’ (as it needed to “cross” 6 permute units). In contrast, referring to FIG. 8B, dataflows for a rotation between coefficients at locations 48 and 50 may be counted as ‘1’ (as the permute units are adjacent).

Returning to FIG. 7, at S720, the required permutations are determined or otherwise derived based on the required rotations and the modulus of the polynomials before each permutation is considered. The modulus relates to the number of residues and directly influences the amount of data needed to be permuted. Permutations are equivalent to rotations of data encoded in polynomial vectors as defined by Equation 1. Typically, the number of permutations is proportional to the number of rotations.

At S730, based on the number of required permutations and a given ordering, the dataflow load is determined. This includes determining how many permutations are fully executed within local permute units and how many would require moving coefficients from one unit to another. The “distance” between units may also be factored in during the determination of dataflow load. It should be noted that the dataflow load is a function of a specific architecture of the hardware accelerator.

It should be noted that S710, S720, and S730 are performed for each set of BTS parameters and that the ordering is derived from the optional orderings.

At S740, the set of BTS (program) parameters and ordering that yields a required dataflow load is selected. In an embodiment, the required dataflow load is predefined. In some embodiments, the required dataflow load is a minimum dataflow load achieving optimal performance, where the optimal performance is measured as a function of compute resource and memory utilization. The dataflow load can be measured as an average power consumption, a bisection bandwidth, or both.

Returning to FIG. 6, at S640, the FHE program is modified to include an instruction or instructions causing placement of the coefficients in the permute units and a performance of the permutations based on the determined optimal ordering and set of program parameters. Further, the FHE program is initialized with the set of optimal parameters. It should be noted that the coefficients may be loaded to internal memory 372 prior to or during the execution of the FHE program or a bootstrapping action.

It should be noted that the placement of the coefficients in a way that reduces the dataflow load ensures optimal performance of the FHE accelerator. Further, such placements may be determined while considering the hardware constraints of the FHE accelerator, such constraints including the memory size of the internal memory, the accelerator's size, and the accelerator's compute resources. It should be further noted that the placement of the coefficients also includes ordering the coefficients within each permute unit 410.

It should be understood that the operations described herein cannot be performed using the human mind or by performing the operation using paper and pencil. A human operator applies subjective criteria to select/simulate/predict, leading to results that are not consistent between different human operators and often not consistent between the same human performing the same task repeatedly, and in particular at the speeds required to provide an operable solution. The number of possible permutations for program parameters, their values, and optional orderings by far exceeds any practical use of the human mind.

Although FIG. 6 shows example blocks of process 600, in some implementations, process 600 may include additional blocks, fewer blocks, different blocks, or blocks that are differently arranged than those depicted in FIG. 6. Additionally, or alternatively, two or more of the blocks of process 600 may be performed in parallel.

Following is an example showing how the disclosed embodiments can significantly reduce the dataflow load. The example will reference the parameters listed in Table 1. This example shows a comparison between a regular ordering and a Bit-Reverse ordering. The dataflow load metrics that would be considered are the average energy consumption and bisection bandwidth.

In this example, for a 2D square layout of coefficients divided into k²=64 units of

$$\frac{N}{{k}^{2}} = 1 \; 024$$

coefficients each. The units are uniformly distributed at a distance of d between each adjacent pair.

Each permute unit is located at a coordinate (x,y)=(i·d,j·d) 0≤i≤7,0≤j≤7. The Manhattan distance between two units is |x₁-x₂|+|y₁-y₂|.

In this example, the following permutations are required:

TABLE 2

| Rotation | Number of times | Percentage |
|---|---|---|
| offset | in program | of total |
| 8192 | 6 | 7.4% |
| 1024 | 16 | 19.8% |
| −256 | 14 | 17.3% |
| −32 | 16 | 17.3% |
| 8 | 14 | 19.8% |
| 1 | 15 | 18.5% |

For the regular ordering, the traditional permutation involves a local permutation (i.e., of 1024 coefficients), a global all-to-all scatter data transfer, and another local permutation for each of the rotation offsets.

The average global (Manhattan) distance traveled is

$${dist}_{avg , regular} = \frac{1}{{k}^{4}} {\sum }_{{x}_{src} = 0}^{k - 1} {\sum }_{{y}_{src} = 0}^{k - 1} {\sum }_{{x}_{tar} = 0}^{k - 1} {\sum }_{{y}_{tar} = 0}^{k - 1} \vert {x}_{src} - {x}_{tar} \vert + \vert {y}_{src} - {y}_{tar} \vert = 5. 25 d$$

For any Bit-Reverse ordering, the rotation offsets 8192,1024, −256, and −32 do not require any global data transfer at all. For a suitable Bit-Reverse based ordering the rotation by 8, the travel distance is d and only the rotation by 1 required a relatively large travel distance of 3.03d thus, the average travel distance is:

$${dist}_{avg , bitrev order} = 0.198 \cdot d + 0.185 \cdot 3.03 d = 0.759 d$$

As can be noticed, in a Bit-Reverse based ordering, the distance used is only 14.4% of the average distance for regular ordering, corresponding to a 7-times decrease in the average energy consumption for the permutations.

For d=2 mm and 14Gb of data undergoing the permutations, an energy cost of

$$40 \frac{fJ}{bit \cdot mm} ,$$

and a runtime of 100 μsec, the average power consumption for the regular ordering and traditional permutation is:

$${P}_{avg , regular} = \frac{5.25 \cdot 2 mm \cdot 14 Gbit \cdot 40 \frac{fJ}{bit \cdot mm}}{100 μsec} = 80 W$$

For the Bit-Reverse ordering, the average power is only P_{avg,bitrev order}=11.6 W.

For the regular ordering, each permutation requires a global all-to-all scatter data transfer, where half of the permuted data crosses the middle cross-section of the permute system. Assuming, for example, a throughput of 1 permutation per 1 nsec the bisection bandwidth required for a single permutation is:

$${BisectionBW}_{regular} = \frac{N}{2} \cdot \frac{1}{1 nsec} = 32768 \cdot {10}^{9} \frac{coeff}{sec}$$

For 32 bit per coefficient,

$${BisectionBW}_{r egular} = 1049 \frac{Tb}{sec} .$$

For the Bit-Reverse ordering, the rotation offsets 8196,1024, −256, and −32 do not require any global data transfer at all. For the rotation by 8 and by 1, there is no crossing at the middle cross-section of the permute system on one axis, and so the added requirement to the system's middle cross-section Bandwidth due to rotations is zero. For the other axis, only the rotation by 1 crosses the middle cross-section, and thus its contribution is bound by

$$\frac{N}{2} . \frac{1}{1 nsec} \cdot 18.5 \%$$

which for 32b per coefficient is

$$194 \frac{Tb}{sec} .$$

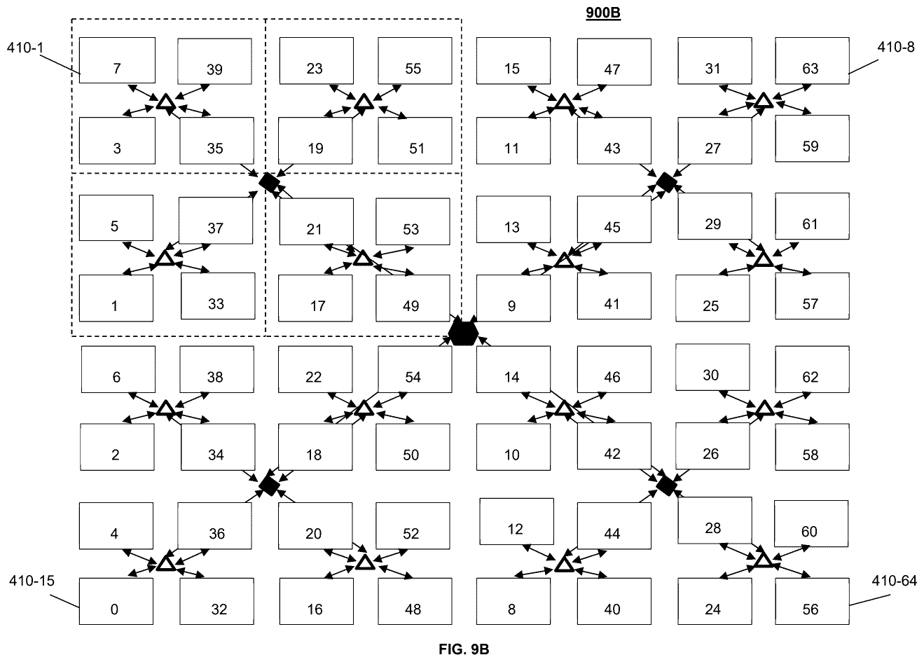

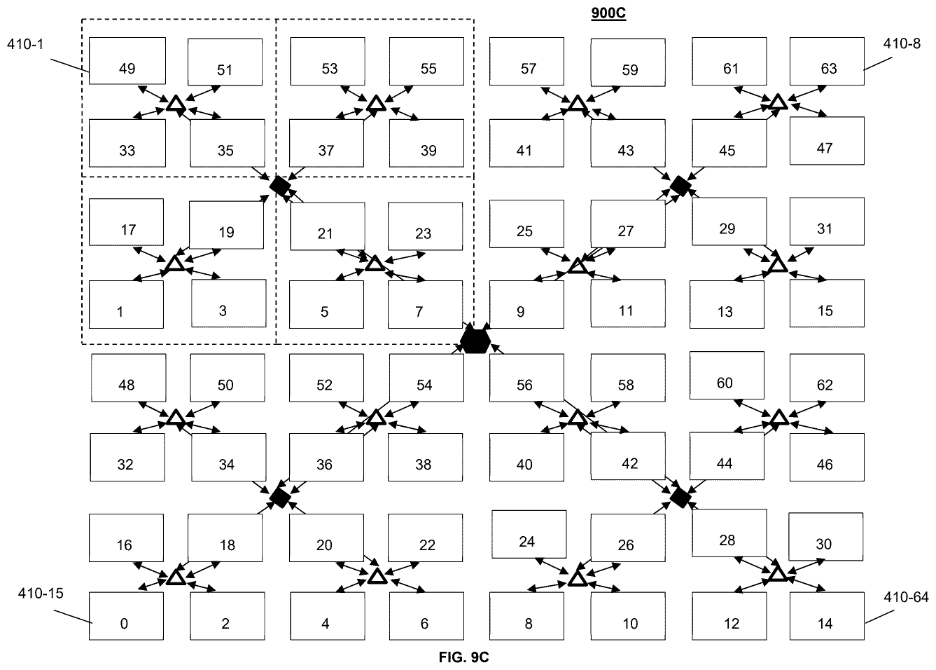

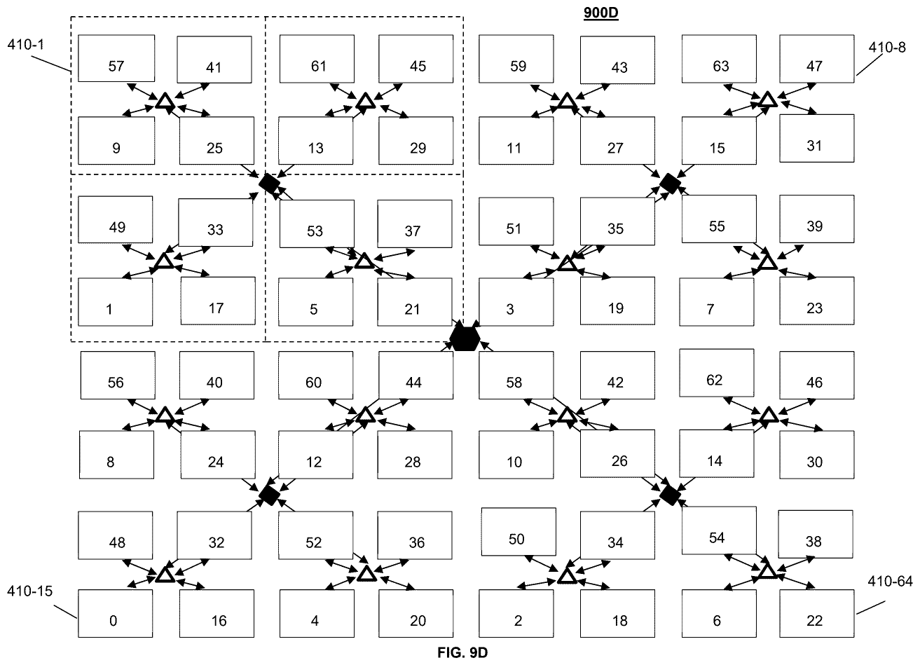

FIG. 9A shows an example arrangement 900A of a regular ordering on an example FHE network according to an embodiment. The example FHE network is shown in FIG. 4. The number in each block represents an index of a polynomial coefficient of a polynomial with 64 coefficients (N=64). For example, a coefficient in location 56 is placed in a permute unit 410-1, a coefficient in location 63 is placed in a permute unit 410-8, and a coefficient in location 0 is placed in a permute unit 410-0, the coefficient in location 7 is placed in a permute unit 410-64, and so on. FIG. 9B shows an example arrangement 900B of one variant of a Bit-Reverse ordering on an example FHE network according to an embodiment. The example FHE network is shown in FIG. 4. The number in each block represents an index of a polynomial coefficient of a polynomial with 64 coefficients (N=64). For example, a coefficient in location 7 is placed in a permute unit 410-1, a coefficient in location 63 is placed in a permute unit 410-8, and a coefficient in location 0 is placed in a permute unit 410-15, the coefficient in location 56 is placed in a permute unit 410-64, and so on.

FIG. 9C shows an example arrangement 9000 of an Even-Odd ordering on an example FHE network according to an embodiment. The example FHE network is shown in FIG. 4. The number in each block represents an index of a polynomial coefficient of a polynomial with 64 coefficients (N=64). For example, a coefficient in location 49 is placed in a permute unit 410-1, a coefficient in location 63 is placed in a permute unit 410-8, and a coefficient in location 0 is placed in a permute unit 410-15, the coefficient in location 14 is placed in a permute unit 410-64, and so on.

FIG. 9D shows an example arrangement 900D of an additional variant of a Bit-Reverse ordering on the FHE network according to an embodiment. The FHE network is shown in FIG. 4. The number in each block represents an index of a polynomial coefficient of a polynomial with 64 coefficients (N=64). For example, a coefficient in location 57 is placed in a permute unit 410-1, a coefficient in location 47 is placed in a permute unit 410-8, and a coefficient in location 0 is placed in a permute unit 410-15, the coefficient in location 22 is placed in a permute unit 410-64, and so on.

In an embodiment, the selected ordering for a FHE bootstrapping process is a Bit-Reverse ordering. In such an ordering, in an example, each consecutive 1024 coefficients are grouped. This configuration allows for each rotation by (2k+1)2ⁱ for i≥5 to remain local, where i is the coefficient's location (or index), and k is an integer number. In such an embodiment, the majority of rotations required in a FHE bootstrapping process are included. That is, this ordering allows the FHE bootstrapping process to perform most permutations within each permute unit 410.

In addition, finer-resolution rotations (such as 1, 2, 4, 8, or 16) can benefit from this ordering. For example, for a consecutive 4096 coefficients after Bit-Reverse, the movement in rotation by 8 can be between adjacent permute units if a suitable Bit-Reverse based ordering is chosen. This is further demonstrated in FIG. 9B.

Following is a description of the identity and frequency of rotation offsets. In a typical program involving linear transformations, ciphertexts undergo rotations. The selection of the program parameters affects the identity of rotation offsets actually being performed and the number of times each rotation offset is required to be performed.

A ciphertext rotation requires a Key Switching Key (KSK), and therefore, the number of usable KSKs may be up to the number of different rotation offsets (unless plaintexts are also rotated). The number of KSKs selected to perform a program depends on tradeoffs between memory and computation (the more keys, the less computation is required, and the more memory is required).

In the case of a single linear transformation, under the assumption that the transforming matrix has n_{nzd} nonzero cyclic diagonals, located at indices {0, res, 2res, . . . (n_{nzd}−1)res}, and the evaluation is performed with the Baby-Step-Giant-Step algorithm, one might choose two parameters n₁, n₂ such that

$${n}_{1} = ⌈ \frac{{n}_{nzd}}{{n}_{2}} ⌉ ,$$

and perform n₁ baby steps followed by n₂ giant steps.

The rotation offsets at the baby steps can be {0, res, 2res, . . . , (n₁−1)res} and the rotation offsets at the giant steps can be {0, n₁res, 2n₁res, . . . (n₂—1)n₁res}. Other sets can also be chosen according to other parameters, but not shown in the example. In this example, the resolution parameter (res) is set to 1.

If BK is the number of baby-step rotation keys, then there are

$$⌈ \frac{{n}_{1} - 1}{BK} ⌉$$

iterations, in each of which there are two polynomial permutations per each of the BK Baby-step rotation keys.

If GK is the number of giant-step rotation keys, then there are

$$⌈ \frac{{n}_{2} - 1}{GK} ⌉$$

iterations, in each of which there are 2 polynomial permutations per each of the GK giant-step rotation keys.

As an example: a matrix multiplication of n_{nzd}=60 diagonals located at indices {0, res, 2res, . . . 59res}. For parameters n₁=10, n₂=6, a set of baby steps at rotation offsets {0, res, 2res, . . . , 9res} is selected, and a set of giant steps at rotation offsets {0,10res, 20res, . . . , 50res}. For BK=3 and choice of baby-step KSK rotation offsets res, 4res, 7res there are 3 iterations with permutations according to each of res, 4res, 7res twice per iteration, resulting in 6 times in total. That is:

$$2 \frac{{n}_{1} - 1}{BK} = 2 \cdot \frac{9}{3} = 6$$

For GK=1 and a choice of baby-step KSK rotation offset 10res, there are 9 iterations, with permutation according to 10res twice per iteration, resulting in 10 times in total. i.e.,

$$2 \frac{{n}_{2} - 1}{BK} = 2 \cdot \frac{5}{1} = 10 .$$

Table 3 summarizes the relationship between rotation offset and number of permutations performed:

TABLE 3

| Rotation | Number of times |
|---|---|
| Offset | permutation is performed |
| res | 6 |
| 4res | 6 |
| 7res | 6 |
| 10res | 10 |

The various embodiments disclosed herein can be implemented as hardware, firmware, software, or any combination thereof. Moreover, the software is preferably implemented as an application program tangibly embodied on a program storage unit or computer-readable medium consisting of parts or of certain devices and/or a combination of devices. The application program may be uploaded to and executed by a machine comprising any suitable architecture. Preferably, the machine is implemented on a computer platform with hardware such as one or more central processing units (“CPUs”), memory, and input/output interfaces. The computer platform may also include an operating system and microinstruction code. The various processes and functions described herein may be either part of the microinstruction code or part of the application program or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

AII examples and conditional language recited herein are intended for pedagogical purposes to aid the reader in understanding the principles of the disclosed embodiment and the concepts contributed by the inventor to further the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for optimizing dataflow load in an accelerator of a fully homomorphic encryption (FHE) program, the accelerator is configured with a FHE network including a plurality of permute units, comprising:
obtaining a set of program parameters;
obtaining a set of optional orderings;
determining optimal program parameters to match an ordering of the set of optimal orderings to yield a required dataflow load; and
modifying a FHE program to place coefficients in the permute units and perform the permutations based on the optimal program parameters and matching ordering.

2. The method of claim 1, wherein an ordering of the set optional ordering defines placements of polynomial coefficients in the plurality of permute units, wherein the polynomial is either a plaintext polynomial or ciphertext polynomial.

3. The method of claim 1, wherein an ordering of the set of optional orderings includes any one of a regular ordering, any bit-reverse ordering, an even-odd ordering, and a permutation-specific ordering.

4. The method of claim 1, wherein determining the optimal program parameters to match an ordering of the set of optimal orderings to yield a minimum dataflow load, further comprises:
for each given set of program parameters and an ordering of the set of optional ordering:
determining a required number of rotations for a given set of program parameters;
deriving required permutations for the required number of rotations for the optional routing;
computing a dataflow load based on the required permutations and a given ordering; and
selecting the set of program parameters and the ordering yielding the required dataflow load.

5. The method of claim 4, wherein performing permutations further comprises:
moving coefficients to form a new shuffled order of the coefficients.

6. The method of claim 4, wherein the minimum dataflow load is achieved most permutations are performed within permute units.

7. The method of claim 4, wherein computing the number of required permutations further comprises: factoring modulus of the polynomial before each permutation.

8. The method of claim 1, wherein the FHE network further comprises: a set of switches, wherein each switch connects a group of permute units.

9. The method of claim 1, wherein the FHE program is a bootstrapping process and the set of program parameters are parameters affecting the bootstrapping process.

10. The method of claim 1, wherein the required dataflow load is predefined.

11. The method of claim 1, wherein the required dataflow load is a minimum dataflow load achieving optimal performance.

12. The method of claim of claim 11, wherein optimal performance is measured as a function of compute resource and memory utilization.

13. The method of claim 11, wherein the dataflow load is measured using at least one of the following metrics: an average power consumption and a bisection bandwidth.

14. A non-transitory computer-readable medium storing a set of instructions for optimizing dataflow load in an accelerator of a fully homomorphic encryption (FHE) program, the set of instructions comprising:
one or more instructions that, when executed by one or more processors of a device, cause the device to:
obtain a set of program parameters;
obtain a set of optional orderings
determine optimal program parameters to match an ordering of the set of optimal orderings to yield a required dataflow load; and
modify a FHE program to place coefficients in the permute units and perform the permutations based on the optimal program parameters and matching ordering.

15. A device for optimizing dataflow load in an accelerator of a fully homomorphic encryption (FHE) program comprising:
one or more processors configured to:
obtain a set of program parameters;
obtain a set of optional orderings
determine optimal program parameters to match an ordering of the set of optimal orderings to yield a required dataflow load; and
modify a FHE program to place coefficients in the permute units and perform the permutations based on the optimal program parameters and matching ordering.

16. The device of claim 15, wherein an ordering of the set optional ordering defines placements of polynomial coefficients in the plurality of permute units, the polynomial is either a plaintext polynomial or ciphertext polynomial.

17. The device of claim 15, wherein an ordering of the set of optional orderings includes any one of a regular ordering, any bit-reverse based ordering, an even-odd ordering, and a permutation-specific ordering.

18. The device of claim 15, wherein the one or more processors, when determining the optimal program parameters to match an ordering of the set of optimal orderings to yield a minimum dataflow load, are configured to:
for each given set of program parameters and an order of the set of optional ordering:
determine a required number of rotations for a given set of program parameters;
derive required permutations for the required number of rotations for the optional routing;
compute a dataflow load based on the required permutations and a given ordering; and
select the set of program parameters and the ordering yielding the required dataflow load.

19. The device of claim 18, wherein the one or more processors, when the performing permutations, are configured to:
move coefficients to form a new shuffled order of the coefficients.

20. The device of claim 18, wherein the minimum dataflow load is achieved most permutations are performed within permute units.

21. The device of claim 18, wherein the one or more processors, when computing the number of required permutations, are configured to:
factor modulus of the polynomial before each permutation.

22. The device of claim 15, wherein the FHE network further comprises:
a set of switches, wherein each switch connects a group of permute units.

23. The device of claim 15, wherein the FHE program is a bootstrapping process and the set of program parameters are parameters affecting the bootstrapping process.

24. The device of claim 15, wherein the required dataflow load is predefined.

25. The device of claim 15, wherein the required dataflow load is a minimum dataflow load achieving optimal performance.

26. The device of claim 25, wherein the dataflow load is measured using at least one of the following metrics:
an average power consumption and a bisection bandwidth.
